(19) United States
(12) Patent Application Publication
(10) Pub. No.: US 2002/0097953 A1
(43) Pub. Date: Jul. 25, 2002

(54) Interfacing fiber optic data with electrical power systems

(76) Inventor: Paul A. Kline, Gaithersburg, MD (US)

Correspondence Address: Woodcock Washburn LLP, 46th Floor, One Liberty Place, Philadelphia, PA, 19103, US

(21) Appl. No.: 10/016,998

(22) Filed: Dec. 14, 2001

Related U.S. Application Data
(60) Provisional application No. 60/255,735, filed on Dec. 15, 2000.

(51) Int. Cl. G02B 6/28; H04B 10/00

(52) U.S. Cl. 385/24; 359/109

(57) ABSTRACT

The invention includes a method, communication network and device for communicating data between a fiber optic data network and an electric power system. The inventive method includes communicating a first data signal on the fiber optic data network, converting the first data signal from the fiber optic data network to a second data signal, and transmitting the second data signal on the electric power system.

### CROSS-REFERENCE TO RELATED APPLICATIONS

This application is based on and claims priority to provisional application 60/255,735 filed Dec. 15, 2000, which is hereby incorporated by reference.

### TECHNICAL FIELD OF THE INVENTIONS

The present invention relates to data communications, and more particularly to data communication systems over electrical power networks.

### BACKGROUND OF THE INVENTION

With the onset of the Internet and other wide-area networks, data communication techniques have moved to the forefront of business and technology concerns. Although sophisticated high-speed data backbones have been built to satisfy the exponentially increasing need for higher data transmission rates, providing corresponding high-speed connection from the backbone to the end user has lagged far behind. In fact, in many cases this connection between the backbone and the end user, often called the “last mile,” has caused the high-speed backbones to be vastly underutilized. For example, while many areas already have incurred the costs of fiber optic backbones, very few can deliver the speed of the fiber optic network to its end users. This last mile problem is a result, in part, of the great expense associated with providing a fiber optic network to each individual user.

Although the difficulty of the “last mile” is especially present in residential settings, the problem also prevails in commercial and industrial settings. As a result of the difficult and expense of installing new last mile networks, the backbone often is connected to networks that already connect to the end user, like telecommunications networks and coaxial cable networks. However, there is another available existing network connected to end users that until recently has gone unnoticed for the high-speed transmission of data.

The electrical power transmission and distribution system currently offers a vast network for providing electrical power to each customer premise. Although this network offers a reliable existing connection to nearly every customer premise, until recently it has not been used as a high-speed data network. Moreover, the electrical power system provides a convenient solution to the last mile problem. The difficulty arises in placing the data signals from the high-speed backbone, like a fiber optic network, on the electric power system.

Therefore, there is a need to transfer data from the high-speed data network to the electrical power system.

### SUMMARY OF THE INVENTION

The invention includes a method, communication network and device for communicating data between a fiber optic data network and an electric power system. The inventive method includes communicating a first data signal on the fiber optic data network, converting the first data signal from the fiber optic data network to a second data signal, and transmitting the second data signal on the electric power system.

The inventive communication network includes a fiber optic data system that carries a first data signal, and an electric power system that carries a second data signal. The network further includes a converter in communication with the fiber optic data system and the electric power system. The converter converts the first data signal to the second data signal, and may convert the second data signal to the first data signal.

### BRIEF DESCRIPTION OF THE DRAWINGS

Other features of the invention are further apparent from the following detailed description of the embodiments of the invention taken in conjunction with the accompanying drawings, of which:

FIG. 1 is a block diagram of an electric power transmission system;

FIG. 2 is a block diagram of a system for transmitting a fiber optic signal over the electric power transmission system, according to the invention;

FIG. 3 is a block diagram of another system for transmitting a fiber optic signal over the electric power transmission system, according to the invention;

FIG. 4 is a block diagram of another system for transmitting a fiber optic signal over the electric power transmission system, according to the invention;

FIG. 5 is a block diagram of another system for transmitting a fiber optic signal over the electric power transmission system, according to the invention;

FIG. 6 is a block diagram of another system for transmitting a fiber optic signal over the electric power transmission system, according to the invention;

FIG. 7 is a block diagram of a fiber optic interface device for transmitting a fiber optic signal over the electric power transmission system, according to the invention; and

FIG. 8 is a flow diagram of a method for transmitting a fiber optic signal over the electric power transmission system, according to the invention.

### DETAILED DESCRIPTION OF THE INVENTION

### Overview of Electric Power Transmission/Distribution System

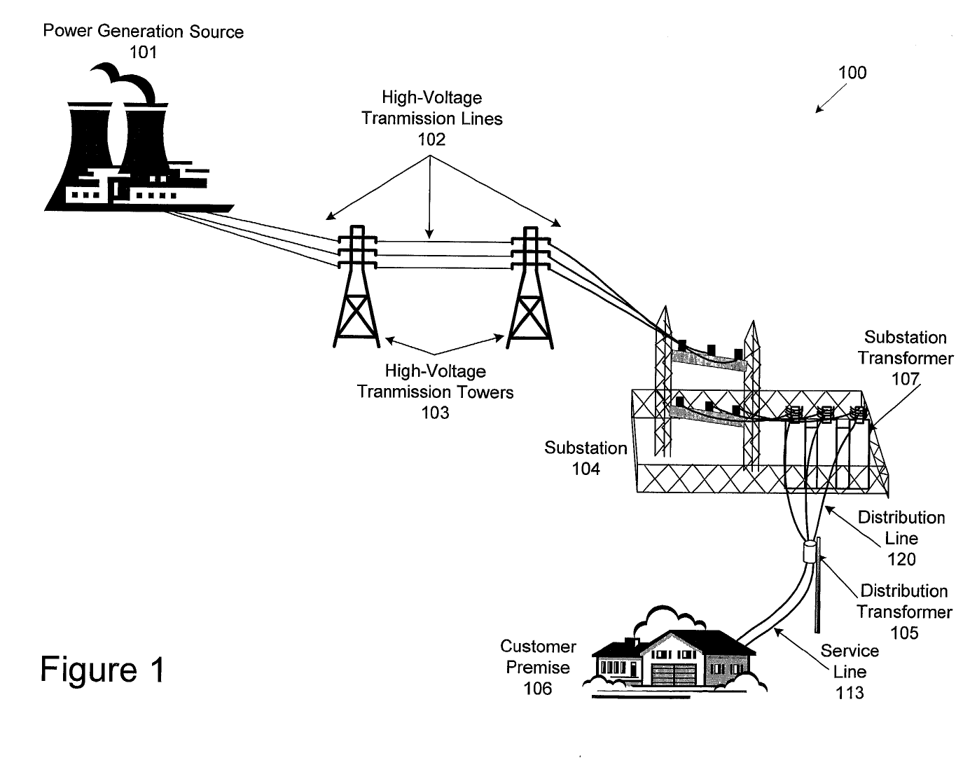

FIG. 1 is a block diagram of an electric power and data transmission system 100. Generally, electric power and data transmission system 100 has three major components: the generating facilities that produce the electric power, the transmission network that carries the electric power from the generation facilities to the distribution points, and the distribution system that delivers the electric power to the consumer. As shown in FIG. 1, a power generation source 101 is a facility that produces electric power. Power generation source 101 includes a generator (not shown) that creates the electrical power. The generator may be a gas turbine or a steam turbine operated by burning coal, oil, natural gas, or a nuclear reactor, for example. In each case, power generation source 101 provides a three-phase AC power. The AC power typically has a voltage as high as approximately 25,000 volts.

A transmission substation (not shown) then increases the voltage from power generation source 101 to high-voltage levels for long distance transmission on high-voltage transmission lines 102. Typical voltages found on high-voltage transmission lines 102 range from 69 to in excess of 800 kilovolts (kV). High-voltage transmission lines 102 are supported by high-voltage transmission towers 103. High-voltage transmission towers 103 are large metal support structures attached to the earth, so as to support the transmission lines and provide a ground potential to system 100. High-voltage transmission lines 102 carry the electric power from power generation source 101 to a substation 104.

Generally, a substation acts as a distribution point in system 100 and provides a point at which voltages are stepped-down to reduced voltage levels. Substation 104 converts the power on high-voltage transmission lines 102 from transmission voltage levels to distribution voltage levels. In particular, substation 104 uses transformers 107 that step down the transmission voltages from the 69-800 kV level to distribution voltages that typically are less than 35 kV. In addition, substation 104 may include an electrical bus (not shown) that serves to route the distribution level power in multiple directions. Furthermore, substation 104 often includes circuit breakers and switches (not shown) that permit substation 104 to be disconnected from high-voltage transmission lines 102, when a fault occurs on the lines.

Substation 104 typically is connected to at least one distribution transformer 105. Distribution transformer 105 may be a pole-top transformer located on a utility pole, a pad-mounted transformer located on the ground, or a transformer located under ground level. Distribution transformer 105 steps down the voltage to levels required by a customer premise 106, for example. Power is carried from substation transformer 107 to distribution transformer 105 over one or more distribution lines 120. Power is carried from distribution transformer 105 to customer premise 106 via one or more service lines 113. Voltages on service line 113 typically range from 240 volts to 440 volts. Also, distribution transformer 105 may function to distribute one, two or all three of the three phase currents to customer premise 106, depending upon the demands of the user. In the United States, for example, these local distribution transformers typically feed anywhere from one to ten homes, depending upon the concentration of the customer premises in a particular location.

### Transmitting a Fiber Optic Signal Over the Electric Power Transmission System

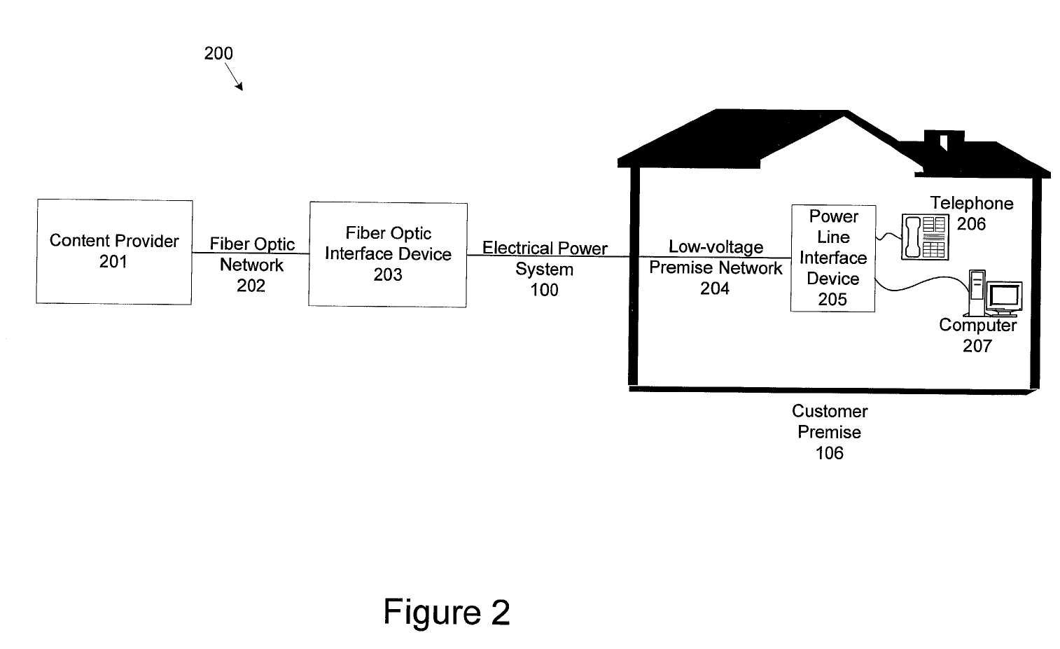

FIG. 2 is a block diagram of a system 200 for transmitting a fiber optic signal over electric power transmission system 100. As will be discussed, other components may be a part of such system 200. However, the components discussed with reference to FIG. 2 are shown for the purposes of clarity and brevity.

As shown in FIG. 2, system 200 includes a content provider 201. Content provider 201 may be any source of information or data relevant to a communication transaction between people or machines. Such content may include audio, video, or text-based content, for example. Content provider 201 is in communication with a fiber optic network. As is well known to those skilled in the art, fiber optic network 202 generally describes a type of data transmission technique that uses fiber optic cables to transmit data in the form of light. Fiber optic cables include a bundle of glass threads each capable of transmitting data that is modulated onto light waves. Typically, data is transmitted digitally and fiber optic networks have much greater bandwidth than other types of communications networks. Fiber optic network 202 may use a number of transmission protocols for communicating the data, including Synchronous Optical Network (SONET) standard. SONET defines a hierarchy of interface rates that allow data streams at different rates to be multiplexed such that data may be carried at rates from 51.8 Megabits per second (Mbps) to 2.48 Gigabits per second (Gbps).

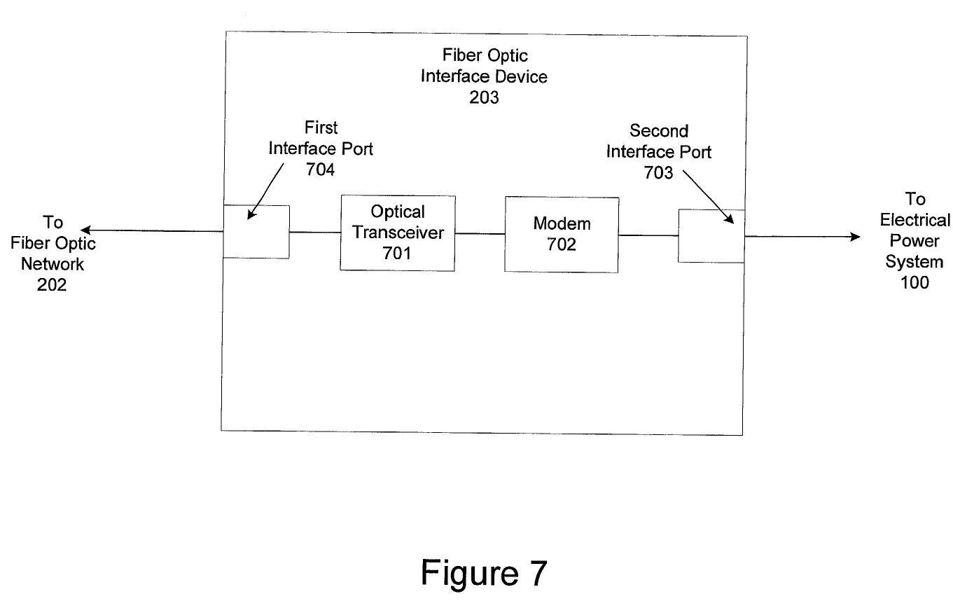

Fiber optic network 202 is in communication with a fiber optic interface device 203. Fiber optic interface device 203 provides an interface between the digital light-modulated data on fiber optic network 202 and the modulated radio frequency signals carried by electrical system 100. Fiber optic interface device 203 converts the digital signal from fiber optic network to an analog signal for use on electrical power system 100, when data is received to customer premise 106. Fiber optic interface device 203 also converts the analog signal from electrical power system 100 to the digital signal for use on fiber optic network 202, when data is transmitted from customer premise 106. Fiber optic interface device 203 will be discussed in greater detail with reference to FIG. 7.

As discussed with reference to FIG. 1, it should be appreciated that electrical power system 100 may include any part of the system from power generation source 101 to customer premise 106. Therefore, fiber optic interface device 203 is not limited by a particular location in, or connection to any particular portion of, electrical power system 100.

Electrical power system 100 is in communication with customer premise 106. In particular, electrical power system 100 connects to a low-voltage premise network 204 via an electrical meter (not shown) and electrical circuit panel (not shown). Low-voltage premise network 204 describes the existing electrical network of cables installed in a premise as part of the in-premise power distribution system. Although not specifically shown in FIG. 2 to maintain clarity and brevity, low-voltage premise network 204 carries the electrical power to various devices (e.g., lighting and receptacles) located in customer premise 106.

Low-voltage premise network 204 is in communication with a power line interface device (PLID) 205. PLID 205 is in communication with various premise devices that are capable of communicating over a data network, including a telephone 206 and a computer 207, for example. PLID 205 operates to convert to a digital signal the analog signal provided over electrical power system 100 by fiber optic interface device 203. Therefore, PLID 205 converts the analog signal to the digital signal for data that is received by customer premise 106, and converts the digital signal to the analog signal for data that is transmitted by customer premise 106. As a result, system 200 permits telephone 206 and computer 207 to transmit and receive data from content provider 201.

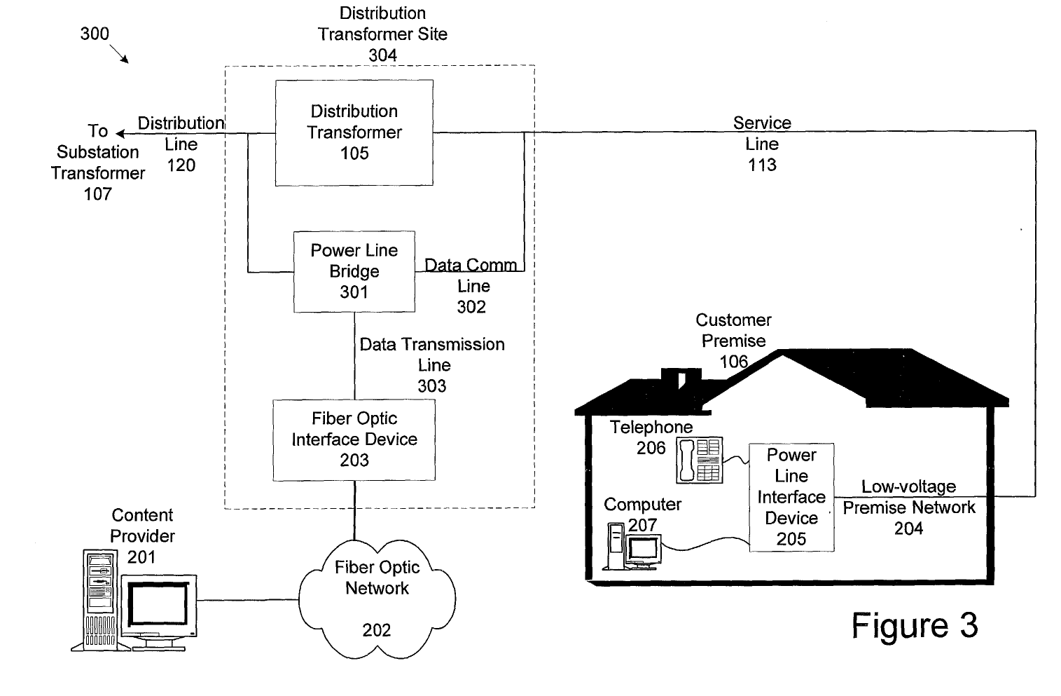

FIG. 3 is a block diagram of another system 300 for transmitting a fiber optic signal over electric power transmission system 100. Although, as discussed, fiber optic interface device 203 is not limited to connection with any particular portion of electrical system 100, FIG. 3 provides one example of connecting fiber optic interface device 203 in electrical power system 100. Therefore, it should be appreciated that connection of fiber optic interface device 203 is not so limited.

The relevant portion of electrical power system 100 is shown in FIG. 3, including distribution transformer 105 receiving power over distribution line 120 from substation transformer 107. Distribution transformer 105 also provides power to customer premise 106 over service line 113. A power line bridge (PLB) 301 is in parallel with distribution transformer 105. PLB 301 operates to receive data from distribution line 120 and to provide such data to service line 113 over data communication line 302. PLB 301 may operate to desirably prevent data from having to pass through distribution transformer 105, while permitting low frequency power signals to continue to pass through distribution transformer 105. Also, PLB 301 may provide electrical isolation. Such electrical isolation may be functionally similar to the electrical isolation traditionally provided by distribution transformer 105, such that high voltage may not undesirably be provided on service line 113 via data communication line 302. Fiber optic interface device 203 may be in communication with power line bridge 301 over a data transmission line 303. As discussed with reference to FIG. 2, fiber optic interface device 203 is in communication with content provider 201 over fiber optic network 202. Distribution transformer 105, PLB 301 and fiber optic interface device 203 may be co-located at a distribution transformer site 304, for ease of installation.

In operation, when data is transmitted from content provider 201 to customer premise 106, fiber optic interface device 203 receives the data via fiber optic network 202. Fiber optic interface device 203 modifies the data from fiber optic network 202 such that it may be carried on service line 113, via power line bridge 301. Such modification may include converting a digital signal from fiber optic network 202 to an analog signal capable of being carried by service line 113. The signal carried by service line 113 is then provided to PLID 205 via low-voltage premise network 204. PLID modifies the signal carried on service line 113 and low-voltage premise network 204 such that telephone 206 and computer 207 may process the data.

Fiber optic interface device 203 also may receive data from customer premise 106 via data transmission line 303. In this instance, telephone 206 and/or computer 207 transmit a signal to PLID 205. PLID 205 modifies the signal from telephone 206 and/or computer 207 for transmission on low-voltage premise network 204 and service line 113, for example into an analog signal. The analog signal is carried to PLB 301 via data communication line 302. PLB 301 directs the analog data signal to fiber optic interface device 203 over data transmission line 303. Fiber optic interface device 203 may convert the signal from an analog signal to a digital signal for transmission to content provider 201 over fiber optic network 202. It should be appreciated, however, that conversion from a digital signal to an analog signal may not be required depending upon the particular characteristics of electrical power system 100.

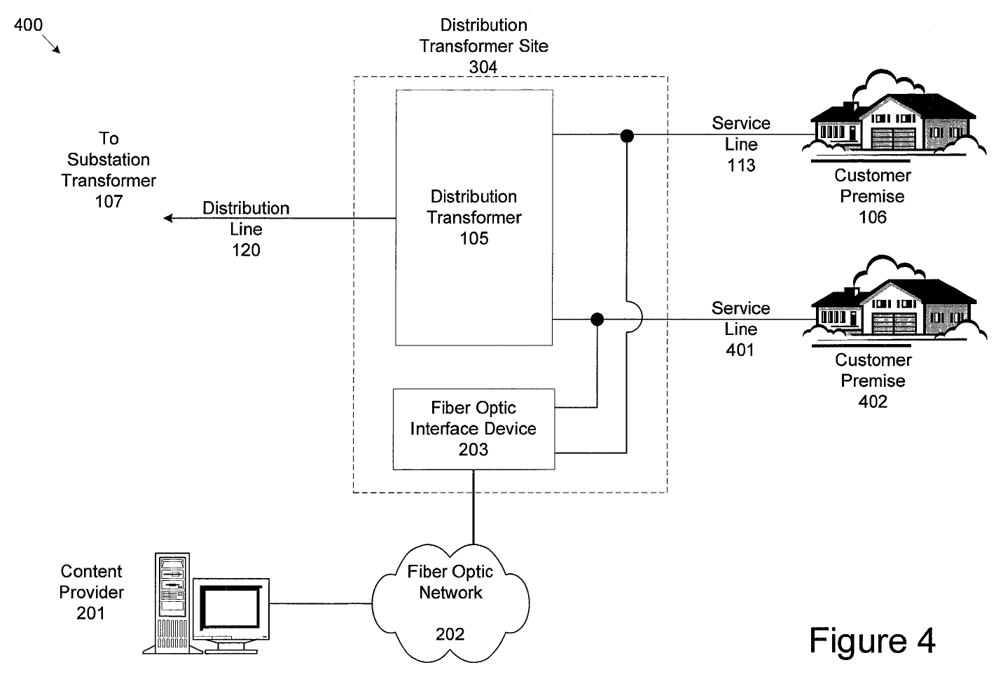

FIG. 4 is a block diagram of another system 400 for transmitting a fiber optic signal over electric power transmission system 100. Although, as discussed, fiber optic interface device 203 is not limited to connection with any particular portion of electrical system 100, FIG. 4 provides one example of connecting fiber optic interface device 203 in electrical power system 100. Therefore, it should be appreciated that connection of fiber optic interface device 203 is not so limited.

As shown in FIG. 4, system 400 has distribution transformer site 304 that includes distribution transformer 105 and fiber optic interface device 203. For system 400, fiber optic interface device 203 is in communication with service line 113 to customer premise 106. Also, fiber optic interface device 203 is in communication with service line 401 to customer premise 402. The remaining components in system 400 operate similarly to those discussed with reference to system 300 in FIG. 3.

In operation, fiber optic interface device 203 receives a data signal from content provider 201 via fiber optic network 202. Fiber optic interface device 203 modifies the data signal from fiber optic network 202 and provides the data signal to service line 113 and/or service line 401. Also, fiber optic interface device 203 may function as a router, well known to those skilled in the art, to distinguish the data sent to customer premise 106 to that sent to customer premise 402. Similarly, when customer premise 106 and/or customer premise 402 transmit data to fiber optic network 202, the signals are carried to fiber optic interface device 203 via service lines 113 and 401, respectively. Fiber optic interface device 203 operates to modify and route the signals as required.

The connections from fiber optic interface device 203 to the service lines may be made at any location in system 400 including at distribution transformer site 304, for ease of installation and access to the service lines. Although not detailed in FIG. 4, it should be appreciated that the connections to the customer premises may be similar to those discussed throughout.

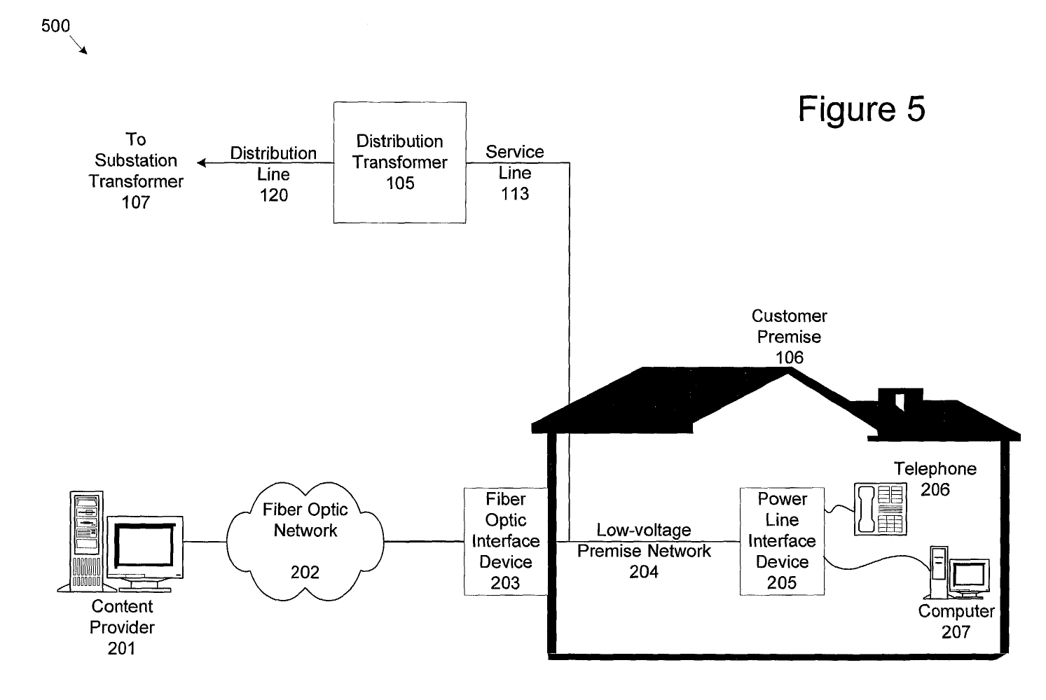

FIG. 5 is a block diagram of another system 500 for transmitting a fiber optic signal over electric power transmission system 100. Although, as discussed, fiber optic interface device 203 is not limited to connection with any particular portion of electrical system 100, FIG. 5 provides one example of connecting fiber optic interface device 203 in electrical power system 100. Therefore, it should be appreciated that connection of fiber optic interface device 203 is not so limited.

As shown in FIG. 5, fiber optic network interface device 203 is located at or near customer premise 106 and is in communication with low voltage premise network 204. The configuration discussed with reference to FIG. 5 is applicable particularly where fiber optic network 202 is available at customer premise 106, and where a premise-based fiber optic network may not be available.

In operation, the data signal is provided from content provider 201 to fiber optic interface device 203 via fiber optic network 202. Fiber optic interface device 203 modifies the data signal from fiber optic network 202 to be carried by low-voltage premise network 204. Also, distribution transformer 105 provides a low frequency voltage signal to low-voltage premise network 204 via service line 113. The voltage signal is provided to the premise's electrical system via low-voltage premise network 204 as normal. Also, the modified data signal is provided to PLID 205 via low-voltage premise network 204. PLID 205 fu the modified data signal to telephone 206 and/or computer 207. Similarly, when data is transmitted by telephone 206 and/or computer 207 to fiber optic network 202, the data is transmitted on low-voltage premise network 204 via fiber optic interface device 203.

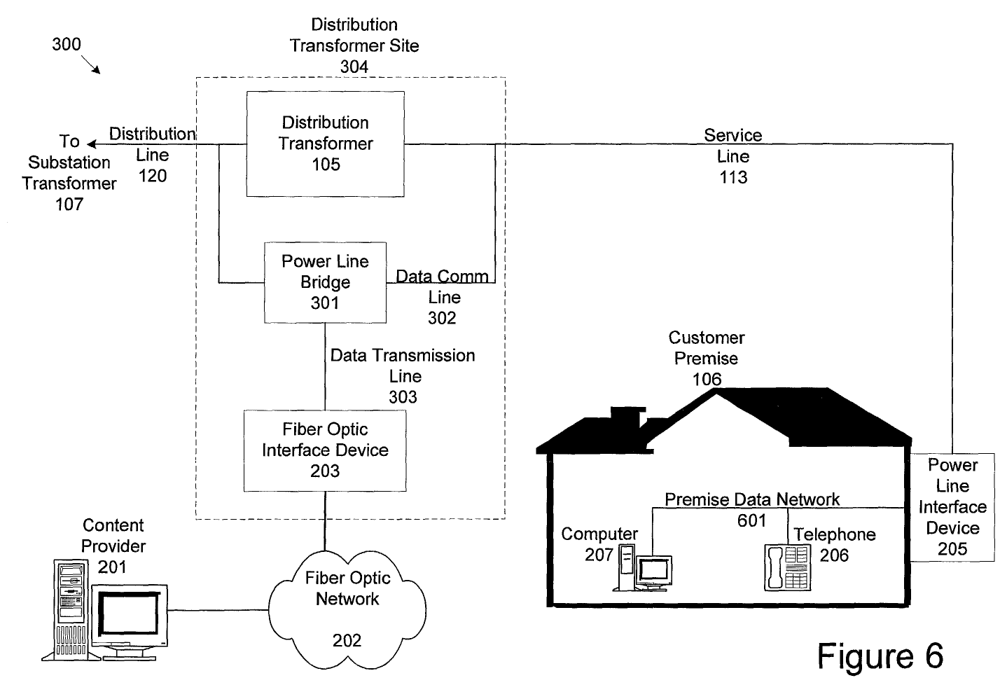

FIG. 6 is a block diagram of another system 600 for transmitting a fiber optic signal over electric power transmission system 100. Although, as discussed, fiber optic interface device 203 is not limited to connection with any particular portion of electrical system 100, FIG. 6 provides one example of connecting fiber optic interface device 203 in electrical power system 100. Therefore, it should be appreciated that connection of fiber optic interface device 203 is not so limited. Also, as discussed, PLID 205 is not limited to connection with any particular portion of electrical system 100, low voltage premise network 204, or customer premise 106. FIG. 6 provides one example of connecting PLID 205 to a premise data network 601 in customer premise 106. Therefore, it should be appreciated that connection of PLID 205 is not so limited.

As shown in FIG. 6, PLID 205 is located at or near the connection of service line 113 with customer premise 106. For example, PLID 205 may be connected to a load side or supply side of an electrical circuit breaker panel (not shown). Alternatively, PLID 205 may be connected to a load side or supply side of an electrical meter (not shown). Therefore, it should be appreciated that PLID 205 may be located inside or outside of customer premise 106. System 600 is particularly applicable where customer premise 106 has a premise data network 601, for example a fiber optic, coaxial and/or telecommunications network. System 600 also is particularly applicable where fiber optic network 202 is not readily available at customer premise 106.

In operation, service line 113 receives a data signal from content provider, via fiber optic network 202, fiber optic interface device 203, and PLB 301. The data signal is provided to PLID 205, which modifies the data signal such that it may be transmitted on premise data network 601 to computer 207 and/or telephone 206. Such modification may include converting an analog signal on service line 113 to a data format acceptable by the particular type of premise data network (e.g., coaxial, fiber optic, or copper). The configuration of system 600 may permit fewer PLIDs to be used to provide data to the premise devices, for example.

FIG. 7 is a block diagram of fiber optic interface device 203 that transmits a fiber optic signal over electric power transmission system 100. Although other components may be used in fiber optic interface device 203, the discussion of such other components is omitted for the purpose of clarity and brevity. However, fiber optic interface device 203 is not so limited.

As shown in FIG. 7, a first interface port 704 on fiber optic interface device 203 is in communication with fiber optic network 202. Also, a second interface port 703 on fiber optic interface device 203 is in communication with electrical power system 100. An optical transceiver 701 is in communication with first interface port 704. A modem 702 is in communication with second interface port 703. It should be appreciated that optical transceiver 701 and modem 702 may be arranged in any configuration within fiber optic interface device 203. For example, although not shown in FIG. 7, modem 702 may be in communication with second interface port 703 and with first interface port 704, with optical transceiver 701 in communication with modem 702. Optical transceiver 701 may be a fiber optic-based transceiver, commercially available from Agere Systems, model number 1417. Also, modem 702 may be a commercially available from Intellon, Inc.'s PowerPack™ chipset.

In operation, when a data signal is transmitted from fiber optic network 202, optical transceiver 701 receives the fiber optic-based signal and provides it to modem 702. Modem 702 modulates the digital signal by converting it to audible tones that can be transmitted on electrical power system 100, for example. Transceiver then transmits the modulated data signal on electrical power system 100 via second interface port 703. When a data signal is received from electrical power system to be sent to fiber optic network 202, optical transceiver 701 receives the data signal and provides it to modem 702. Modem 702 demodulates the data signal to a digital signal capable of being transmitted on fiber optic network 202. Optical transceiver 701 then transmits the demodulated data signal to fiber optic network 202 via first interface port 704. Although not specifically detailed, it should be appreciated that fiber optic interface device 203 operates in a similar manner for data transmitted to fiber optic network 202 from electric power system 100. For example, fiber optic interface device 203 may be a bi-directional communication device.

Fiber optic interface device 203 also may have certain router functionality, well known to those skilled in the art. For example, as discussed with reference to FIG. 4, where fiber optic interface device 203 provides data sources to various in-premise networks, fiber optic interface device 203 may identify certain data headers and a forwarding table to determine to which customer premise the data should be transmitted. Such a configuration also may permit each device (e.g., telephone and computer) to have a unique identifying network address.

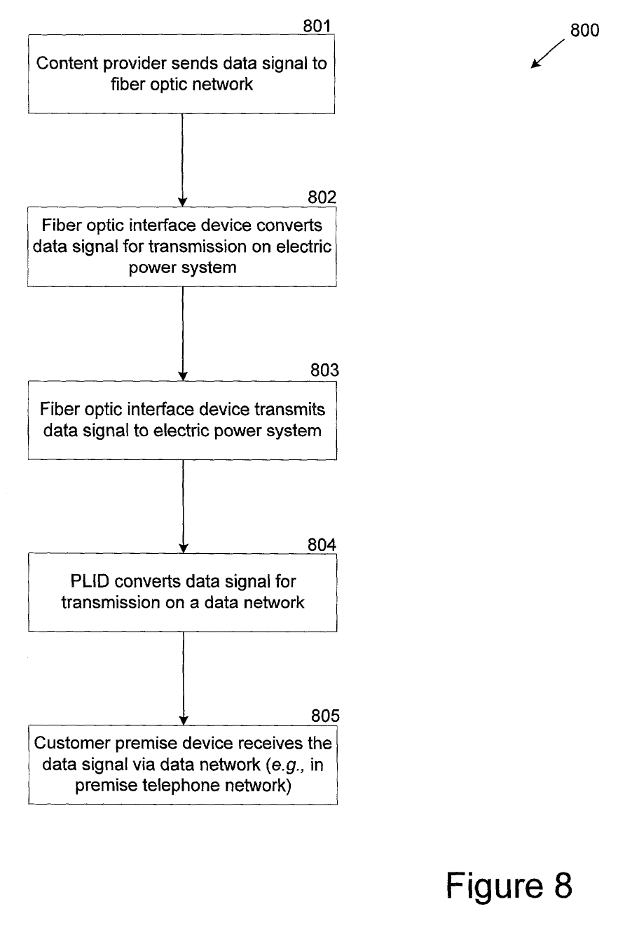

FIG. 8 is a flow diagram of a method 800 for transmitting a fiber optic signal over electric power system 100. It should be appreciated that method 800 details just one example of a technique for transmitting a fiber optic signal over electric power system 100, and that the invention is not so limited.

In step 801, content provider 201 sends the data signal to fiber optic network 202. In step 802, fiber optic interface device 203 converts the data signal for transmission on electric power system 100. In step 803, fiber optic interface device 203 transmits the data signal to electric power system 100. In step 804, PLID 205 converts the data signal for transmission on a data network, like an in-premise telephone network for example. In step 805, a customer premise device (e.g., telephone 206) receives the data signal via the in-premise data network.

The invention is directed to a system and method for transmitting a data signal on an electric power system. It is noted that the foregoing examples have been provided merely for the purpose of explanation and are in no way to be construed as limiting of the invention. While the invention has been described with reference to certain embodiments, it is understood that the words that have been used herein are words of description and illustration, rather than words of limitations. For example, the invention may apply equally to other than low-voltage premise networks, as well as being applied to any part of electric power and data transmission system. Further, although the invention has been described herein with reference to particular means, materials and embodiments, the invention is not intended to be limited to the particulars disclosed herein. Rather, the invention extends to all functionally equivalent structures, methods and uses, such as are within the scope of the appended claims.

Those skilled in the art, having the benefit of the teachings of this specification, may effect numerous modifications thereto and changes may be made without departing from the scope and spirit of the invention in its aspects. Those skilled in the art will appreciate that various changes and adaptations of the invention may be made in the form and details of these embodiments without departing from the true spirit and scope of the invention as defined by the following claims.

What is claimed is:

1. A method for communicating data between a fiber optic data network and an electric power system, comprising:
communicating a first data signal on the fiber optic data network;
converting the first data signal to a second data signal; and
communicating the second data signal on the electric power system.

2. The method of claim 1, wherein the first data signal is a fiber optic-based signal.

3. The method of claim 1, wherein the second data signal is an analog signal.

4. The method of claim 3, wherein the analog signal is modulated with a radio frequency signal.

5. The method of claim 1, wherein the first data signal is received on the fiber optic data network.

6. The method of claim 1, wherein the first data signal is transmitted on the fiber optic data network.

7. The method of claim 1, wherein the second data signal is received on the electric power system.

8. The method of claim 1, wherein the second data signal is transmitted on the electric power system.

9. The method of claim 1, wherein a fiber optic interface device converts the signals.

10. The method of claim 1, wherein the electric power system is a low-voltage premise system located within a customer premise.

11. The method of claim 1, wherein the electric power system is a low-voltage distribution system.

12. The method of claim 1, wherein the electric power system is a medium-voltage distribution system.

13. The method of claim 1, wherein the electric power system is a high-voltage transmission system.

14. The method of claim 1, further comprising converting the second data signal to a third data signal, wherein the third data signal is capable of being transmitted on a telecommunications network.

15. The method of claim 14, wherein a power line interface device converts the second data to the third data signal.

16. The method of claim 14, wherein the telecommunications network is a customer premise telephone network.

17. The method of claim 14, wherein the telecommunications network is a customer premise coaxial cable network.

18. The method of claim 1, wherein the first data signal is communicated with a content provider via the fiber optic data network.

19. The method of claim 1, further comprising routing data communicated with fiber optic network and electrical power system.

20. A device for converting data between a fiber optic data network and an electric power system, comprising:
a first interface port for communicating a first data signal from the fiber optic data network;
a second interface port for communicating the second data signal on the electric power system; and
a converter in communication with the first interface port and the second interface port for converting the first data signal to a second data signal to be communicated on the electric power system.

21. The device of claim 20, wherein the converting comprises modifying the first data signal from a digital signal to an analog signal.

22. The device of claim 20, wherein the converting comprises modifying the second data signal from an analog signal to a digital signal.

23. The device of claim 20, wherein the converter comprises a fiber optic transceiver.

24. The device of claim 20, wherein the converter comprises a modem.

25. The device of claim 20, wherein the converter comprises a router.

26. The device of claim 20, wherein the first data signal is a fiber optic-based signal.

27. The device of claim 20, wherein the second data signal is an analog signal.

28. The device of claim 20, wherein the converter converts the second data signal to a first data signal to be communicated on fiber optic data network.

29. The device of claim 20, wherein the electric power system is a low-voltage premise system located within a customer premise.

30. The device of claim 20, wherein the electric power system is a low-voltage distribution system.

31. The device of claim 20, wherein the electric power system is a medium-voltage distribution system.

32. The device of claim 20, wherein the electric power system is a high-voltage transmission system.

33. The device of claim 20, further comprising converting the second data signal to a third data signal, wherein the third data signal is capable of being transmitted on a telecommunications network.

34. The device of claim 33, wherein the telecommunications network is a customer premise telephone network.

35. The device of claim 33, wherein the telecommunications network is a customer premise coaxial cable network.

36. A communication network, comprising:
a fiber optic data system that carries a first data signal;
an electric power system that carries a second data signal; and
a converter in communication with the fiber optic data system and the electric power system, wherein the converter converts the first data signal to the second data signal.

37. The communication network of claim 36, further comprising a power line interface device in communication with the electric power system and a telecommunication network.

38. The communication network of claim 37, further comprising a premise data network in communication with the power line interface device.

39. The communication network of claim 37, where in the power line interface device converts the second data signal to a third data signal that is carried by the telecommunications network.

40. The communication network of claim 37, wherein the telecommunications network is in communication with a network device.

41. The communication network of claim 40, wherein the network device includes at least one of the following: a telephone, a computer, a facsimile machine, a television, and a household appliance.

42. The communication network of claim 36, wherein converter converts the second data signal to the first data signal.

43. The communication network of claim 36, wherein the electric power system is in communication with a network device.

44. The communication network of claim 43, wherein the network device includes at least one of the following: a telephone, a computer, a facsimile machine, a television, and a household appliance.

45. The communication network of claim 36, further comprising an electric transformer in communication with the electric power system.

46. The communication network of claim 36, further comprising a power line bridge in communication with the electric power system and the fiber optic data network.

47. The communication network of claim 45, wherein the electric transformer is in communication with the converter.

48. The communication network of claim 36, wherein the first data signal is a fiber optic-based signal.

49. The communication network of claim 36, wherein the second data signal is an analog signal.

50. The communication network of claim 36, wherein the electric power system is a low-voltage premise system located within a customer premise.

51. The communication network of claim 50, wherein the converter is in direct connection with the low-voltage premise system.

52. The communication network of claim 36, wherein the electric power system is a low-voltage distribution system.

53. The communication network of claim 52, wherein the converter is in direct connection with the low-voltage distribution system.

54. The communication network of claim 36, wherein the electric power system is a medium-voltage distribution system.

55. The communication network of claim 54, wherein the converter is in direct connection with the medium-voltage distribution system.

56. The communication network of claim 36, wherein the electric power system is a high-voltage transmission system.

57. The communication network of claim 56, wherein the converter is in direct connection with the high-voltage transmission system.

58. A method for communicating data between a fiber optic data network and an electric power system, comprising:
receiving a fiber optic data signal with an optical transceiver;
modulating the fiber optic data signal with a radio frequency signal;
creating an analog signal; and
transmitting the analog signal to the electric power system.

59. The method claim 58, further comprising:
receiving the analog signal from the electric power system;
converting the analog signal to a premise-based data signal; and
providing the premise-based data signal to a network device.

60. A method for communicating data between a fiber optic data network and an electric power system, comprising:
receiving a premise-based data signal from a network device;
converting the premise-based data signal to an analog signal; and
providing the analog signal to the electric power system.

61. The method claim 60, further comprising:
receiving the analog signal from the electric power system;
demodulating the analog signal with a radio frequency signal;
creating a fiber optic data signal;
receiving the fiber optic data signal with an optical transceiver; and
transmitting the fiber optic data signal to the fiber optic data network.
